(19) United States
(12) Patent Application Publication
(10) Pub. No.: US 2025/0051212 A1
(43) Pub. Date: Feb. 13, 2025

(54) SELF-HEALING OXIDES FOR IONIZING RADIATION DAMAGE

(71) Applicant: The Aerospace Corporation, El Segundo, CA (US)

(72) Inventors: Eric Joseph NEMANICK, Santa Monica, CA (US); Don WALKER, Whittier, CA (US); Vicky Doan-Nguyen TRIGG, Redondo Beach, CA (US); Jann Albert GROVOGUI, Redondo Beach, CA (US); Glenn E. BEAN, JR., Gardena, CA (US); Pilar ESPINET GONZALEZ, Pasadena, CA (US)

(73) Assignee: The Aerospace Corporation, El Segundo, CA (US)

(21) Appl. No.: 18/447,867

(22) Filed: Aug. 10, 2023

(51) Int. Cl. C03B 25/02; C03B 1/00

(52) U.S. Cl. CPC C03B 25/025; C03B 1/00

(57) ABSTRACT

A method for fabricating self-healing glass includes processing a water-based or water-containing oxide material for fabrication of self-healing glass. The method includes performing a thermal annealing process on the material, and manufacturing the self-healing glass from the thermal annealed material.

### FIELD

The present invention relates to a self-healing material, and more particularly, to a self-healing oxide that regenerates after being damaged from ionizing radiation.

### BACKGROUND

Oxide materials in high radiation environments, such as space, nuclear reactors, and medical radiotherapy, need to be robust to ionizing radiation damage, which reduces the optical transmission of the oxide materials and coatings. These materials and coatings are needed to protect instruments, focus, transmit or reflect light, change the emissivity, or reduce electrostatic discharge of key components, all which can be degraded by ionizing radiation damage from their environment.

Ionizing radiation, such as gamma rays, alpha particles, beta radiation, high energy electrons, protons or other high energy particles, degrade oxides by breaking bonds within the oxide, and/or displacing atoms in the oxide. These defects generated within the oxide cause damage to the oxide by forming defects with broken chemical bonds, distorted atomic structure, and vacant energy states. These defects can interact with light through absorption, and are visible externally as the oxide darkening, taking on a brown or dark gray or other color. When these oxides are needed for their transparency or light transmission, for example as a lens or lens coating, this darkening reduces the lens's capability to effectively pass light, reducing the capability of a lens to focus light, or for a coverglass to transmit light energy.

Currently, high radiation environment materials are needed for many applications, such as space photovoltaics protected by an oxide coverglass, oxide lenses for optical instruments for nuclear reactor inspection, and medical scopes for targeting radiotherapy treatments. These applications use a silicon oxide glass material that is doped with cerium, a Rare Earth element. These cerium doped silicon oxide materials resist degradation from ionizing radiation through this cerium doping, which reduces the accumulation of damage to the oxide materials over time, extending the duration the devices using the cerium doped oxide materials can be used. However, this resistance to damage does not repair ionizing radiation damage done, only slows the effects of the damage.

Without cerium doping, the silicon oxides accumulate ionization damage that is photoactive, absorbing ever more of the light that would be passed through the silicon oxide, reducing the sunlight available for the photovoltaics, the sample light from the inspection tools, or reduce the visibility of the target in the medical instrument. Cerium doping can extend instrument life through reducing the rate at which damage accumulates, but cannot stop the accumulation of damage from ionizing radiation. In addition, while there are cerium doped ionizing radiation resistant bulk materials, that is materials that are rigid enough to hold their shape without a substrate or frames, there are no ionizing radiation resistant oxide coatings or thin films (1 μm or less), needed for surface reflection suppression, emissivity alteration, chromatic aberration control, or other benefits. Currently, these coatings become darker over mission life from their accumulated damage, reducing the effectiveness of the material they coat.

While cerium doping slows the accumulation of damage from ionizing radiation, it does not halt it, allowing for the damage to build up, eventually reducing the transparency of the cerium doped oxides. What is needed is a material that does not slowly accumulate damage, but rather heals itself from this damage, preventing rather than slowing the accumulation of ionizing radiation damage.

In addition to the existing cerium doped silicon glasses and oxides for ionizing radiation resistance, other elemental oxide materials are also important as lenses, coatings, and tools for light manipulation. Currently, there are no non-silicon oxides that have been shown to resist/reject/heal ionizing radiation damage. Key oxides such as tin oxides for emissivity control, indium oxide for conductivity, zinc oxide for UV absorption, and other oxides can only be used by accepting the inevitable degradation from ionizing radiation in their environment. Cerium doping cannot be used with these materials, and as such there is a need for a method to create ionizing radiation environment non-silicon oxide materials.

Self-healing oxides use an internal chemical reaction to heal themselves from the ionizing radiation damage rather than resist the damage as in cerium doping for silicon glass. The presence of reactive water within the oxide material allows for ionizing radiation damage sites, that would otherwise absorb light, to be healed through reaction with the water in the oxide. The light absorbing ionizing radiation damage sites can be healed through this reaction, returning that location within the oxide to its original starting condition of being optically transparent. These oxide materials can contain copious amounts of water, hundreds of mg per g of the oxide, allowing for ionizing radiation damage location to always have water nearby (within 1 nm) to react with, and then heal that damage, and prevent the accumulation of damage that would otherwise create defect sites that absorb light and shorten the life of the material.

Accordingly, a self-healing oxide material may be beneficial.

### SUMMARY

Certain embodiments of the present invention may provide solutions to the problems and needs in the art that have not yet been fully identified, appreciated, or solved by current oxide technologies. For example, some embodiments of the present invention pertain to self-healing oxide materials to ionizing radiation damage.

In an embodiment, a method for fabricating self-healing glass includes processing a water-based or water-containing oxide material for fabrication of self-healing glass. The method includes performing a thermal annealing process on the material, and manufacturing the self-healing glass from the thermal annealed material.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a diagram illustrating the formation of defects in an oxide from ionizing radiation, as well as healing of that defect from water present in the material, according to an embodiment of the present invention.

FIG. 2 is a flow diagram illustrating a process for fabricating self-healing glasses through a water annealing processing of bulk oxides, according to an embodiment of the present invention.

FIG. 3 is a flow diagram illustrating a process for synthesis of hydrated bulk oxides from water containing materials, according to an embodiment of the present invention.

FIG. 4 is a flow diagram illustrating a process for synthesis of hydrated bulk oxides from an intermediate step in conventional fabrication, according to an embodiment of the present invention.

FIG. 5 is a flow diagram illustrating a process for fabricating self-healing glasses through hydrothermal processing of thin film oxides, according to an embodiment of the present invention.

FIG. 6 is a flow diagram illustrating a process for synthesis of hydrated bulk oxides from water containing materials, according to an embodiment of the present invention.

FIG. 7 is a flow diagram illustrating a process for synthesis of hydrated thin film oxides from an intermediate step in conventional fabrication, according to an embodiment of the present invention.

### DETAILED DESCRIPTION OF THE EMBODIMENTS

Some embodiments generally pertain to self-healing oxides to ionizing radiation damage. In some embodiments, oxides containing 0.1 to 10 percent water by mass is used. Oxides, such as silicon dioxide, tin oxide, zinc oxide, and indium oxide, may form a solid solution with water across all concentration in these oxides. The nature of the oxygen in the chemical structure of the oxides allows the protons of the incorporated water to move rapidly throughout the material, by migrating from one oxygen to another, whether from a ‘water’ oxygen or an ‘oxide’ oxygen. The use of water introduces protons (e.g., the hydrogen from water) that are free to move throughout the material by hopping from one oxygen to the next.

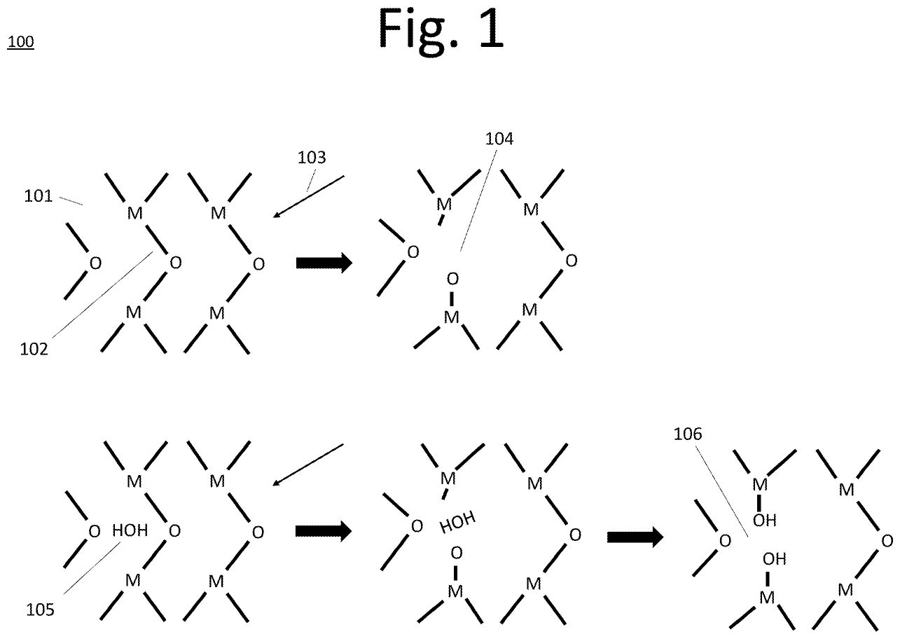

These mobile protons from the incorporated water heal the ionizing radiation induced photoactive damage sites causing those site such that they no longer absorb light. FIG. 1 is a diagram illustrating the formation of defects in an oxide from ionizing radiation, as well as healing of that defect from water present in the material, according to an embodiment of the present invention. As shown in FIG. 1, oxide material 101 contains bonds 102 between the metallic components (e.g., silicon, tin, indium, zinc or other metal or semimetal such as germanium, aluminum, gallium, or a transition metal), that can be broken through interaction with ionizing radiation 103. This creates a defect 104, that absorbs incoming light, disrupting the function of the previously transparent oxide. However, for an oxide material that contains water 105 dispersed in the material, the defect site generated from interaction with the ionizing radiation subsequently is healed through the reaction of that water with the defect site forming bonds to site 105 transforming to a healed site 106. These damage sites before healing are optically absorbing, and reduce the light transmission of the material. The healed sites no longer absorb visible light and the material retains its clarity, healing the damage from the ionizing radiation damage effects. It should be noted that the mechanical, optical, and chemical properties of the oxide may be unchanged through the introduction of water in the material. This means that the mechanical strength for oxides used as photovoltaic coverglasses, the light refraction needed for optical lenses, the emissivity for radiative surfaces, and the reflective properties for antireflection coatings, are retained. This allows the self-healing oxide material to still be used in high radiation environments, where current cerium doped radiation resistant silicon glasses are used. Furthermore, this allows for the utilization of these self-healing oxides as thin films, as well as new bulk oxides. These thin films are made using silicon or non-silicon oxides including tin oxide, zinc oxide, indium oxide, and other metal or semimetal oxides. In some embodiments, the oxide is self-healing to radiation damage, not merely unaffected by ionizing radiation, or reducing ionizing radiation damage.

There are two classes of approach for forming self-healing oxide materials-one is for bulk materials (e.g., coverglasses or lenses for optical or protective materials) and the other is for thin coatings (e.g., hydrated oxide thin films) on other materials. With bulk materials, such as silicon oxide for photovoltaics (solar cells), the self-healing material (which is hydrated to 0.1 to ten percent water content) is ionized by incoming radiation creating a light absorbing defect site. The self-healing material then recovers its optical clarity through a chemical reaction between the defect site with nearby water hydrogen. The optical absorption of this post reaction site may now lie outside of the optical region, allowing light to pass through the oxide without being absorbed, effectively healing the material of the radiation induced damage. Synthesis of bulk, thick glasses (>1 μm) can be performed through water diffusion in an existing glass, a low cost treatment; oxide synthesis through reactions of water based precursors; and finally through the selective dehydration of an oxide from conventional manufacturing processing. These processes can be performed to fabricate a range of oxides, including silicon, tin, zinc, indium and other oxide types.

With thin (<1 μm) films, oxide coatings containing water can be synthesized through dip coating, spray coating, spin coating, sputtering, or other thin film deposition process. These coatings are hydrated using several methods, including water diffusion into the coating, synthesis using water precursors that remain after synthesis, or through the selective dehydration of the oxide thin film after conventional manufacturing. After the deposition, these oxide coatings are used in a high radiation environment to provide a range of coating properties, such as antireflection, emissivity modification, refraction adjustment, electrical conductivity or other properties, without reduction in optical transmission.

In some embodiments, the fabrication bulk (>1 μm thick) oxides of silicon, tin, zinc, indium, germanium or other metallic or semi-metallic oxides is from exposure to a water-containing environment, where a water content and distribution within the oxide is targeted from the transport of water into the material from the environment.

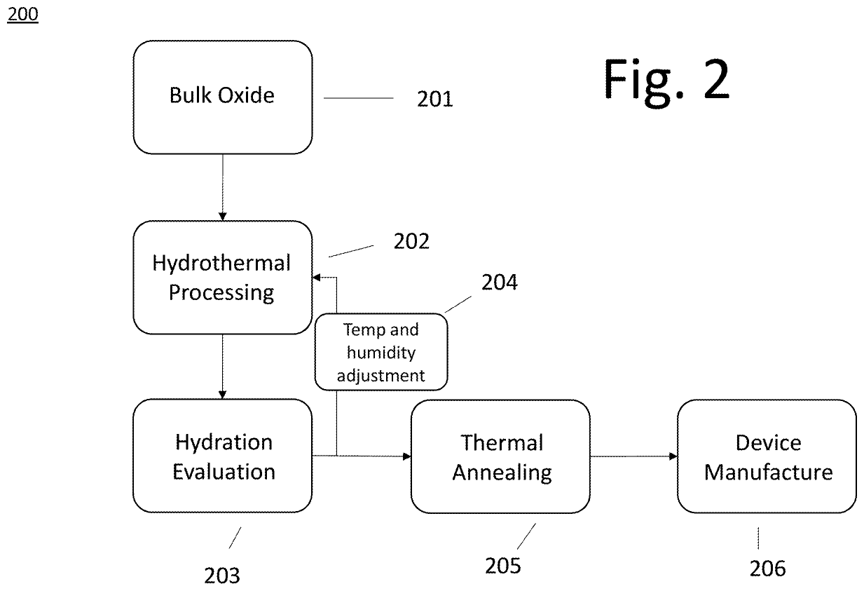

FIG. 2 is a flow diagram illustrating a process 200 for fabricating self-healing glasses through a water annealing processing of bulk oxides, according to an embodiment of the present invention. At 201, bulk oxides, thicker than 1 μm and being composed of silicon, zinc, tin, indium or other oxide, are subjected to a hydrothermal processing. At 202, hydrothermal processing involves elevated temperatures and/or pressures in an environment containing a controlled fraction of water in a gaseous or liquid state. After exposure of the bulk oxide to the high temperatures and/or pressures in a water environment, the bulk oxides are evaluated to the desired hydration level at 203. Hydration target levels for the oxide are between 0.1-10% water by mass. This includes optical, gravimetric, electric, or other water detection methods for total water content and spatial water content. If the desired concentration or distribution of water in the bulk oxides are not met, process 200 is returned to 202, potentially after adjustment of 202's temperature, pressure, or water concentration. Steps 202 through 204 are repeated until desired water concentration and distribution are met, after which the now hydrated oxides undergo a final thermal annealing process at 205, thereby achieving final mechanical properties prior to being manufactured into the final device at 206.

In some embodiments, the fabrication of bulk (>1 μm thick) oxides of silicon, tin, zinc, indium, or other metallic or semi-metallic oxides are from synthesis from water-containing precursors. This is where a water content and distribution within the oxide is targeted from the synthesis process.

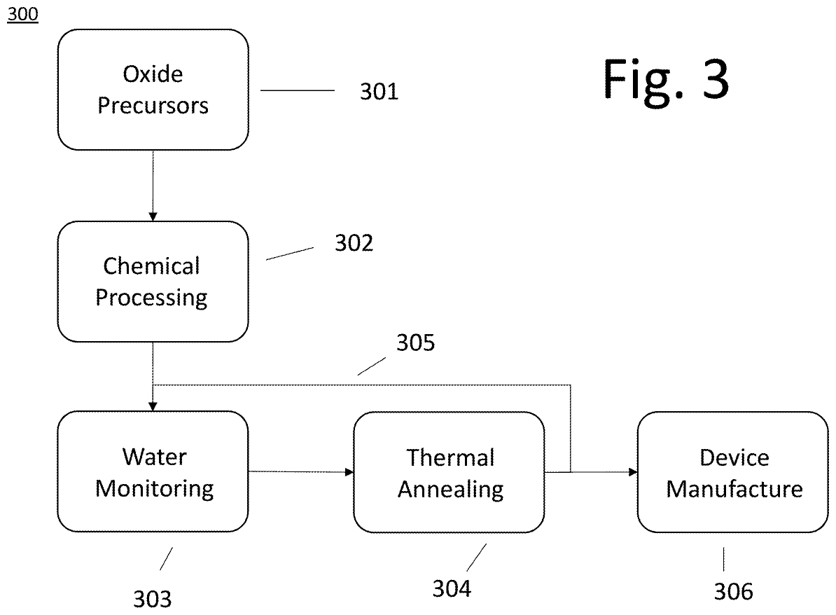

FIG. 3 is a flow diagram illustrating a process 300 for synthesis of hydrated bulk oxides from water containing materials, according to an embodiment of the present invention. At 301, water based or water containing materials are used as precursors to oxide formation. For example, compounds (e.g., silicon chloride, tin chloride, zinc chloride, indium chloride, or nitrates of these elements, chlorates, sulfates, phosphates or other delivery compounds) are in aqueous solutions. These water based or water containing materials are compounds of elements (e.g., Si, Sn, Zn, In) with simple ions (e.g., fluorine, iodine, bromine, complex ions (e.g., acetate, bromate, chlorate, or nitrate), or as suspensions of materials or particles in a water based or water containing state). These precursors undergo chemical processing to form a desired oxide or an intermediate oxide at 302. Process 300 may involve heat, light, pressure, or an activating chemical to transform the oxide precursors into the desired oxide or intermediate oxide. After undergoing water monitoring at 303, the amount and distribution of water is evaluated. Water monitoring includes optical, gravimetric, electric, or other water detection methods for total and spatial water content. Hydration target levels for the oxide are between 0.1-10% water by mass. At 304, the material undergoes thermal annealing, where the amount of water is reduced before being returned 305 to water evaluation for content and distribution. Otherwise, the processed oxide precursors are deployed for final use and device manufacturing 306.

In some embodiments, the fabrication of bulk (>1 μm thick) oxides of silicon, tin, zinc, indium, or other metallic or semi-metallic oxides is accomplished after conventional fabrication of the oxide. This is where the water content of the oxide is reduced to a target value.

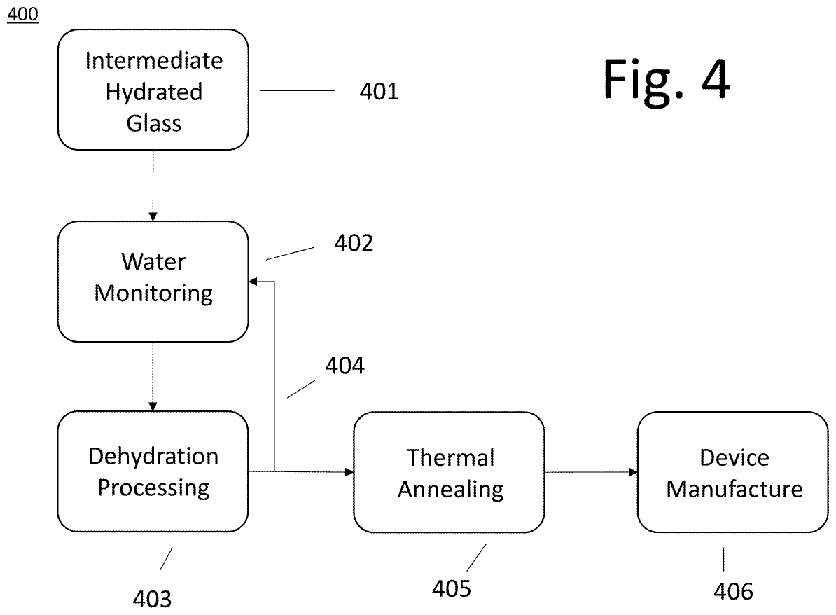

FIG. 4 is a flow diagram illustrating a process 400 for synthesis of hydrated bulk oxides from an intermediate step in conventional fabrication, according to an embodiment of the present invention. In many conventional bulk glass fabrication methods, water in the glass is a byproduct of fabrication, and steps are taken to reduce or remove the water. In some embodiments, at 401, intermediate hydrated glass is evaluated for water content and water distribution. At 402, water monitoring is performed on the intermediate hydrated glass using optical, gravimetric, electric, or other water detection methods for total and spatial water content before the intermediate hydrated glass undergoes a dehydration process. At 403, the dehydration process involves elevated temperature or reduced pressure to lower the water content of the oxide. Hydration target levels for the oxide are between 0.1-10% water by mass. At 404, the water content and distribution of the intermediate hydrated glass is re-evaluated, and if the water content is lowered to the target content, process 400 moves forward to thermal annealing at 405 and subsequently to device manufacturing at 406. Otherwise, process 400 returns to 402 for water monitoring.

In some embodiments, the fabrication of thin (<1 μm thick) oxides of silicon, tin, zinc, indium, or other metallic or semi-metallic oxides of is from exposure to a water-based environment. This is where a water content and distribution within the oxide is targeted.

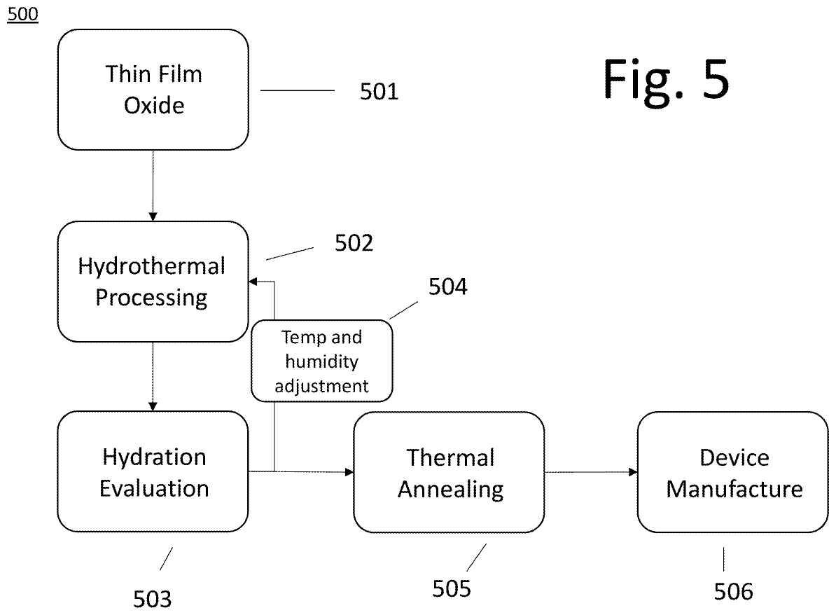

FIG. 5 is a flow diagram illustrating a process 500 for fabricating self-healing glasses through hydrothermal processing of thin film oxides, according to an embodiment of the present invention. At 501, a thin film oxide, which is thinner than 1 μm, and is composed of silicon, zinc, tin, or indium, or other oxide, is fabricated on a substrate. At 502, the thin film oxide is subjected to a hydrothermal processing. In this embodiment, hydrothermal processing includes elevating temperatures and/or pressures in an environment containing a controlled fraction of water in a gaseous or liquid state. After exposing the thin film oxide to the high temperature and/or pressure in a water environment, the thin film oxide is evaluated for a desired hydration level at 503. The hydration evaluation includes optical, gravimetric, electric, or other water detection methods for total and spatial water content. If the desired concentration and/or distribution of water in the thin film oxide is not met, process 500 returns to 502. This is where process 500 repeats 502 through 504 until desired water concentration and distribution are met. Hydration target levels for the oxide are between 0.1-10% water by mass. Once the desired water concentration and distribution levels are met, the hydrated oxide undergoes a final thermal annealing process at 505 to achieve final mechanical properties. After that, the hydrated oxide is manufactured into a final device at 506.

In some embodiments, the fabrication of thin (<1 μm thick) oxides of silicon, tin, zinc, indium, or other metallic or semi-metallic oxides of is from synthesis from water-containing precursors. This is where a water content and distribution within the oxide is targeted from the synthesis process.

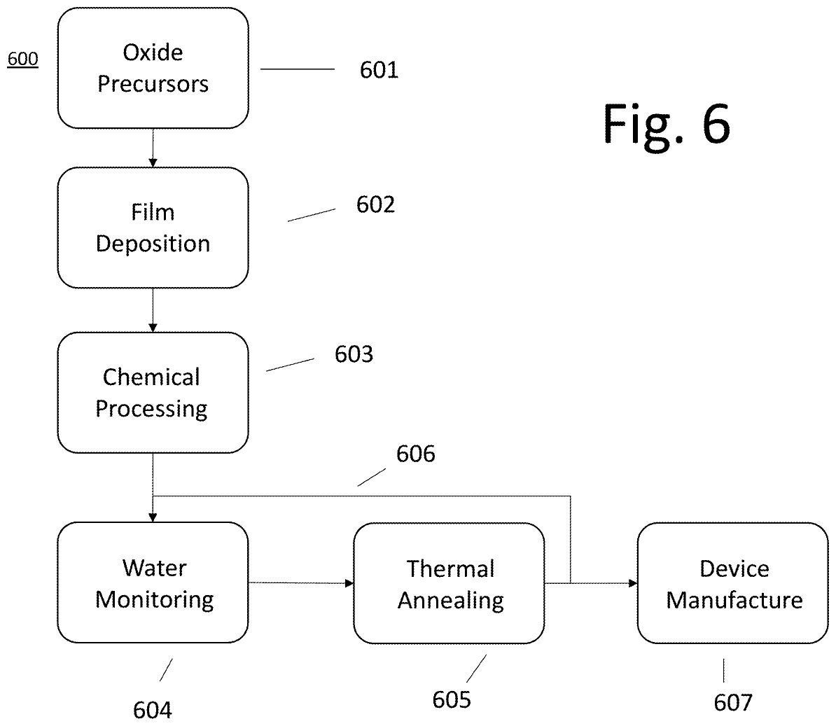

FIG. 6 is a flow diagram illustrating a process 600 for synthesis of hydrated bulk oxides from water containing materials, according to an embodiment of the present invention. In this embodiment, process 600 begins at 601 with using water based or water containing materials as precursors to oxide formation. For example, compounds such as silicon chloride, tin chloride, zinc chloride, indium chloride, or nitrates of these elements, or chlorates, sulfates, phosphates or other delivery compounds. These materials can also be compounds of elements (e.g., Si, Sn, Zn, In) with simple ions (e.g., fluorine, iodine or bromine, complex ions (e.g., acetate, bromate, or chlorate or nitrate), or as suspensions of materials or particles in a water based or water containing state). At 602, the precursors are deposited as a thin film on a substrate through spray coating, dip coating, doctor blading, evaporation, sputtering, or other film deposition process, thereby forming a precursor thin film. At 603, the precursor thin films undergo chemical processing to form a desired oxide or an intermediate oxide. This chemical process may involve heat, light, pressure, or an activating chemical to transform the precursor thin films into the desired oxide or intermediate oxide. After undergoing a water monitoring process at 604, which includes optical, gravimetric, electric, or other water detection methods for total and spatial water content, the amount and distribution of water is evaluated. Hydration target levels for the oxide are between 0.1-10% water by mass. At 605, the material may undergo thermal annealing, where the amount of water is reduced prior to returning to 606. At 606, water evaluation is performed for content and distribution or is deployed for final use and device manufacture at 607.

In some embodiments, the fabrication of thin films (<1 μm thick) oxides of silicon, tin, zinc, indium, or other metallic or semi-metallic oxides of is accomplished after conventional fabrication of the oxide thin film. This is where the water content of the oxide is reduced to a target value.

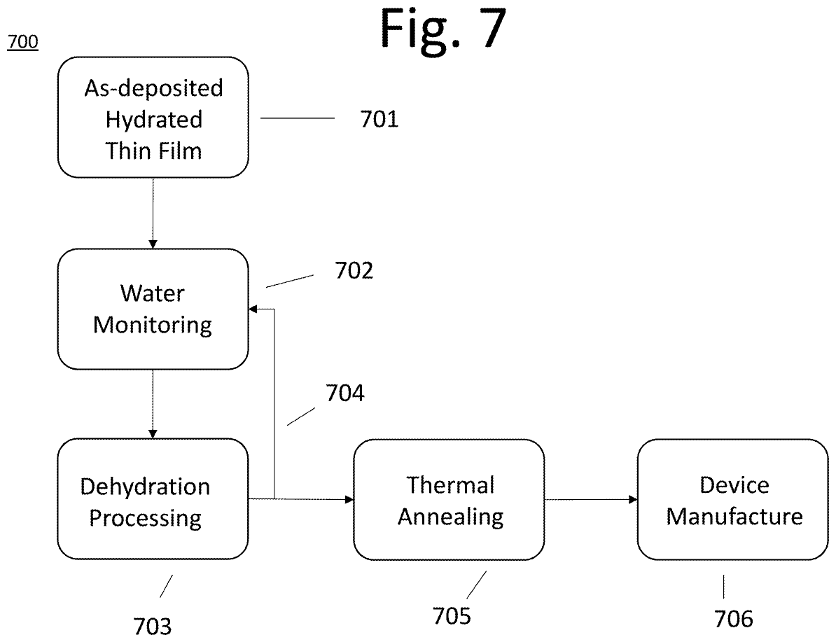

FIG. 7 is a flow diagram illustrating a process 700 for synthesis of hydrated thin film oxides from an intermediate step in conventional fabrication, according to an embodiment of the present invention. In many conventional thin film oxide fabrication methods, water in the oxide is a byproduct of fabrication, and steps are taken to reduce or remove the water. In process 700, intermediate hydrated oxide thin film is retrieved at 701, and at 702, the intermediate hydrated oxide thin film is evaluated for water content and distribution. The evaluation may include optical, gravimetric, electric, or other water detection methods for total and spatial water content. After this, at 703, the thin film is sent to a dehydration process. This may involve elevating temperature or reducing pressure to lower the water content of the oxide. At 704, the water content and distribution is evaluated again, and if the water content has been lowered to the target content, process 700 may proceed to final thermal annealing at 705 and on to device manufacturing at 706. Hydration target levels for the oxide are between 0.1-10% water by mass.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A method for fabricating self-healing glass, comprising:
processing a water-based or water-containing oxide material for fabrication of self-healing glass;
performing a thermal annealing process on the material; and
manufacturing the self-healing glass from the thermal annealed material.

2. The method of claim 1, wherein the processing of the water-based or water-containing oxide material comprises
creating the water-based or water-containing oxide material by exposing it to water or a water containing environment in the presence of heat and/or pressure; and
evaluating the water-based or water-containing material.

3. The method of claim 1, wherein the processing of the water-based or water-containing oxide material comprises
Fabricating the water-based or water-containing oxide material from oxide aqueous chemical precursors forming a desired oxide or an intermediate oxide; and
performing water monitoring on the water-based or water-containing oxide material, wherein the water monitoring comprises evaluating an amount of water and a distribution of the water.

4. The method of claim 1, further comprising:
evaluating water content and water distribution in intermediate hydrated glass;
performing water monitoring on the intermediate hydrated glass using water detection methods for total water content and spatial water content; and
performing dehydration process on the intermediate hydrated glass to lower the water content of oxide in the intermediate hydrated glass; and
re-evaluating the water content and water distribution in intermediate hydrated glass.

5. The method of claim 1, further comprising:
creating the water-based or water-containing oxide thin film material by exposing the oxide film to water or a water containing environment in the presence of heat and/or pressure; and
evaluating the thin film oxide for a desired hydration level.

6. The method of claim 1, further comprising:
using water based or water containing material as a precursor to oxide formation;
depositing the precursor as a thin film on a substrate through film deposition process, thereby forming a precursor thin film;
performing undergo chemical processing on the thin films to form a desired hydrated oxide or an intermediate oxide; and
performing water monitoring on the precursor.

7. The method of claim 1, further comprising:
retrieving an intermediate hydrated oxide thin film;
evaluating the intermediate hydrated oxide thin film for water content and water distribution;
performing a dehydration process on the intermediate hydrated oxide thin film by elevating temperature or reducing pressure to lower the water content of an oxide in the intermediate hydrated oxide thin film; and
evaluating the water content and the water distribution prior to performing thermal annealing.

8. A method for fabricating self-healing glass, comprising:
processing a water-based or water-containing oxide material for fabrication of self-healing glass, wherein the processing of the water-based or water-containing oxide material comprises
creating the water-based or water-containing oxide material by exposing it to water or a water containing environment in the presence of heat and/or pressure;
performing a thermal annealing process on the material; and
manufacturing the self-healing glass from the thermal annealed material.

9. The method of claim 8, wherein the processing of the water-based or water-containing oxide material comprises
evaluating the water-based or water-containing material.

10. The method of claim 8, wherein the processing of the water-based or water-containing oxide material comprises
Fabricating the water-based or water-containing oxide material from oxide aqueous chemical precursors forming a desired oxide or an intermediate oxide; and
performing water monitoring on the water-based or water-containing oxide material, wherein the water monitoring comprises evaluating an amount of water and a distribution of the water.

11. The method of claim 8, further comprising:
evaluating water content and water distribution in intermediate hydrated glass;
performing water monitoring on the intermediate hydrated glass using water detection methods for total water content and spatial water content; and
performing dehydration process on the intermediate hydrated glass to lower the water content of oxide in the intermediate hydrated glass; and
re-evaluating the water content and water distribution in intermediate hydrated glass.

12. The method of claim 8, further comprising:
creating the water-based or water-containing oxide thin film material by exposing the oxide film to water or a water containing environment in the presence of heat and/or pressure; and
evaluating the thin film oxide for a desired hydration level.

13. The method of claim 8, further comprising:
using water based or water containing material as a precursor to oxide formation;
depositing the precursor as a thin film on a substrate through film deposition process, thereby forming a precursor thin film;
performing undergo chemical processing on the thin films to form a desired hydrated oxide or an intermediate oxide; and
performing water monitoring on the precursor.

14. The method of claim 8, further comprising:
retrieving an intermediate hydrated oxide thin film;
evaluating the intermediate hydrated oxide thin film for water content and water distribution;
performing a dehydration process on the intermediate hydrated oxide thin film by elevating temperature or reducing pressure to lower the water content of an oxide in the intermediate hydrated oxide thin film; and
evaluating the water content and the water distribution prior to performing thermal annealing.

15. A method for fabricating self-healing glass, comprising:
processing a water-based or water-containing oxide material for fabrication of self-healing glass, wherein the processing of the water-based or water-containing oxide material comprises
creating the water-based or water-containing oxide material by exposing it to water or a water containing environment in the presence of heat and/or pressure, and
evaluating the water-based or water-containing material;
performing a thermal annealing process on the material; and
manufacturing the self-healing glass from the thermal annealed material.

16. The method of claim 15, wherein the processing of the water-based or water-containing oxide material comprises
fabricating the water-based or water-containing oxide material from oxide aqueous chemical precursors forming a desired oxide or an intermediate oxide; and
performing water monitoring on the water-based or water-containing oxide material, wherein the water monitoring comprises evaluating an amount of water and a distribution of the water.

17. The method of claim 15, further comprising:
evaluating water content and water distribution in intermediate hydrated glass;
performing water monitoring on the intermediate hydrated glass using water detection methods for total water content and spatial water content; and
performing dehydration process on the intermediate hydrated glass to lower the water content of oxide in the intermediate hydrated glass; and
re-evaluating the water content and water distribution in intermediate hydrated glass.

18. The method of claim 15, further comprising:
creating the water-based or water-containing oxide thin film material by exposing the oxide film to water or a water containing environment in the presence of heat and/or pressure; and
evaluating the thin film oxide for a desired hydration level.

19. The method of claim 15, further comprising:
using water based or water containing material as a precursor to oxide formation;
depositing the precursor as a thin film on a substrate through film deposition process, thereby forming a precursor thin film;
performing undergo chemical processing on the thin films to form a desired hydrated oxide or an intermediate oxide; and
performing water monitoring on the precursor.

20. The method of claim 15, further comprising:
retrieving an intermediate hydrated oxide thin film;
evaluating the intermediate hydrated oxide thin film for water content and water distribution;
performing a dehydration process on the intermediate hydrated oxide thin film by elevating temperature or reducing pressure to lower the water content of an oxide in the intermediate hydrated oxide thin film; and
evaluating the water content and the water distribution prior to performing thermal annealing.
